(19) United States
(12) Patent Application Publication
(10) Pub. No.: US 2013/0085991 A1
(43) Pub. Date: Apr. 4, 2013

(54) Reverting a Current State Model of a Database to a Pre-refactored State

(71) Applicants: Jeffery S. Welden, Sammamish, WA (US); Christopher Aaron Rickman, Redmond, WA (US); Jamie D. Laflen, Bellevue, WA (US); Yang Gao, Redmond, WA (US)

(72) Inventors: Jeffery S. Welden, Sammamish, WA (US); Christopher Aaron Rickman, Redmond, WA (US); Jamie D. Laflen, Bellevue, WA (US); Yang Gao, Redmond, WA (US)

(73) Assignee: MICROSOFT CORPORATION, Redmond, WA (US)

(21) Appl. No.: 13/252,021

(22) Filed: Oct. 3, 2011

(51) Int. Cl. G06F 17/30

(52) U.S. Cl. 707/634; 707/E17.005

(57) ABSTRACT

The subject disclosure is directed towards transforming model elements, associated with a current state model of a database, to a pre-refactored state. While applying refactoring operations on the database, identity change information is created that comprises each model element associated with the refactoring operations. Using the identity change information, a pre-refactored state model of the database is created. Using the model element in the pre-refactored state, a visual representation of a comparison between the pre-refactored state model and the current state model is produced.

### BACKGROUND

Databases represent a class of software that can continue to run even while changes are being applied. Database developers and administrators take advantage of this capability to modify database systems while running so as to minimize the impact of database availability on users. Different database developers can work on different versions of a same production database and collaborate on these versions at a later date. For example, at any time the database developers may compare a model (i.e., a collection of schema definitions) associated with a local database project to another model associated with a remote database.

Various database systems allow the database developers to import a set of schema definitions from the remote database (e.g., a development database, a test database, or a production database) into the local database project, perform various refactoring operations on model elements and subsequently deploy an updated set of schema definitions to the remote database. Problems arise during such deployment because contemporary database systems update the remote database with the refactoring operations subsequent to comparing a current model of the remote database with the model associated with the local database project.

A model comparison component of the database system uses model identifiers (e.g., schema names, table names, column names and/or the like) in order to find corresponding model elements. If any of these model identifiers change during refactoring (e.g., during a rename or a move schema operation), the model comparison component fails to recognize the corresponding model elements. As a result, a post-refactored model element and a pre-refactored model element are dropped from the database project model and the database model, respectively. Vice versa, the post-refactored model element and the pre-refactored model element are added to the database model and the database project model, respectively.

Identifying the corresponding model elements in a global manner is often impractical and typically relies upon having the database systems implement a central identifier system that manages the globally-unique identifiers across all the different sources during the length of the development session (and may extend to all persisted sessions that can be restored later). Furthermore, the central identifier system impacts tools and features that rely on the identification of the corresponding model elements.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed to reverting a current state model of a database to a pre-refactored state. In one aspect, a deployment engine records pre-refactored versions of model elements that were renamed or moved into another schema into identity change information. In another aspect, the deployment engine also records any dependency differences. Accordingly, the identity change information includes the model element in a pre-refactored state and a post-refactored state as well as composed child model elements, parent model elements and/or peer model elements.

In one aspect, the identity change information permits the deployment engine to perform various refactoring operations on model elements while producing a model comparison result that indicates an equivalency between the model elements and corresponding model elements in the pre-refactored state. In another aspect, the deployment engine may modify the model comparison result to show that the model elements in the post-refactored state are updated. In another aspect, a visualization tool is able to produce a visual representation of the modified model comparison result.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram illustrating an exemplary system for transforming model elements, associated with a current state model of a database, to a pre-refactored state according to one example implementation.

FIG. 2 illustrates exemplary identity change information according to one example implementation.

FIG. 3 illustrates an exemplary modified comparison result between a current state model of a database and a pre-refactored state model according to one example implementation.

FIG. 4 is a flow diagram illustrating exemplary steps for transforming model elements, associated with a current state model of a database, to a pre-refactored state according to one example implementation.

FIG. 5 is a flow diagram illustrating exemplary steps for creating identity change information comprising each model element that is associated with refactoring operations according to one example implementation.

FIG. 6 is a block diagram representing exemplary non-limiting networked environments in which various embodiments described herein can be implemented.

FIG. 7 is a block diagram representing an exemplary non-limiting computing system or operating environment in which one or more aspects of various embodiments described herein can be implemented.

### DETAILED DESCRIPTION

Various aspects of the technology described herein are generally directed towards to transforming model elements in a current state model associated with a database to a pre-refactored state. As explained herein, when schema definitions are imported into an offline representation of the database (i.e., a model associated with a database project), a declarative system may perform refactoring operations on one or more model elements before deployment. For example, software code in the form of declarative statements in a data definition language (DDL), such as Structured Query Language (SQL), may be executed in order to rename one or more model elements and move other model elements to another schema. The model elements may include tables that are renamed and/or moved to a different schema.

During deployment, the refactoring operations, which may be logged into a Extensible Markup Language (XML) file, are replayed on the database. The refactoring operations are added to a deployment script that, when executed, updates the model elements in the database. For example, corresponding tables in the database are renamed and/or moved to the different schema. Accordingly, the corresponding tables in the database and the tables in the offline representation have identical identifiers and show up as equivalent in a model comparison result. By altering a status of the corresponding tables to updated, a schema comparison engine may revert the corresponding tables to a pre-refactored state using identity change information. In one exemplary implementation, a visualization tool may produce a visual representation of the model comparison result to present the reverted corresponding tables in a tree-grid view.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and testing in general.

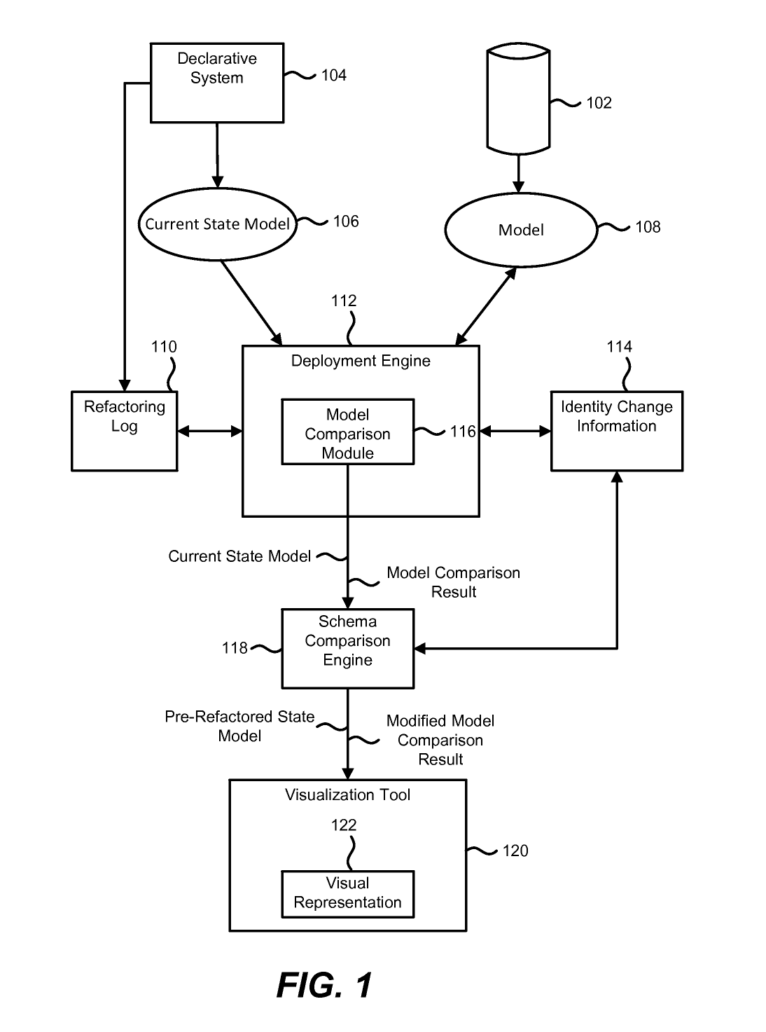

FIG. 1 is a block diagram illustrating an exemplary system for transforming model elements, associated with a post-refactored state of a database 102, to a pre-refactored state according to one example implementation. A declarative system 104 utilizes code-based tooling concepts that process an offline source representation of the database 102, such as a current state model 106. In one exemplary implementation, the current state model 106 is a database project that is created using schema definitions that are reverse-engineered from the database 102 as explained herein. As the declarative system 104 modifies the current state model 106 in an isolated environment without committing such modifications to the database 102.

In one exemplary implementation, the declarative system 104 executes various refactoring operations by adding, modifying or deleting schema definitions in the current state model 106. In one exemplary implementation, the refactoring operations include renaming a model element and converting uses of or references to that model element name changed throughout the database project. In one exemplary implementation, the declarative system 104 renames tables, columns, views, or other model elements and propagates those changes to the rest of the database project, which includes associated unit tests, views, stored procedures, triggers and/or the like. Hence, the current state model 106 becomes a source model for use during deployment of the database project as explained herein.

The database 102 includes structured data in various forms, such as views, tables and/or the like, that are organized into schemas. Each schema definition includes a logical grouping of model elements such as tables, views, stored procedures, triggers and/or the like. Each table is further defined as a collection of columns where each includes one or more properties (e.g., a data type, a primary key constraint, nullable or not null and/or the like) and one or more relationships (e.g., a foreign key relationship). By accessing (e.g., reverse-engineering) the schema definitions, a model 108 representing the database 102 is created. As explained herein, the model 108 is a target model for use during deployment of the database project represented by the current state model 106 according to one exemplary implementation.

Accordingly, a refactoring log 110 includes information (e.g., an XML change log file) associated with refactoring operations that require special handling during the deployment. For example, when renaming a model element on the current state model 106, an entry is added to the refactoring log 110. When deploying the rename operation on the target model 108, the refactoring log 110 ensures that the corresponding model element in the model 108 is renamed as intended. Otherwise, the corresponding model element is dropped, and a new model element is created with a new name.

Furthermore, when renaming the model element, other model elements that reference the renamed model elements are automatically updated with the new name. For example, if a column in a table is renamed, any stored procedures that reference that column are automatically updated with the new name. As another example, when dividing one schema into multiple schemas to increase security or organize the database 102 more logically, one or more model elements are moved to a new schema and, in addition, fully qualified references to these model elements is updated.

In one exemplary implementation, a deployment engine 112 creates the database project (e.g., a SQL Server Database project using Visual Studio) by importing or extracting the schema definitions from the database 102. Then, the declarative system 104 uses declarative statements in a data definition language (e.g., Transact-SQL, SQL and/or the like) to refactor model elements in the database project by altering schema definitions, table definitions and/or or column properties. For example, the declarative system 104 executes a schema move operation (e.g., an ALTER SCHEMA statement) or a rename operation (e.g., sp_rename stored procedure) on one or more tables and/or columns.

When executing a particular refactoring operation on a certain model element, information associated with that operation is recorded in a refactoring log 110, such as whether the model element can be renamed or moved to another schema using a sp_rename procedure or an ALTER statement, respectively, instead of using DROP and ADD statements. In addition, each entry in the refactoring log 110 may include various attributes, such as a unique identifier (i.e., a GUID) and an author. Those two attributes plus the name and location of the change file itself form a unique identifier for a particular change.

The refactoring log 110 is used at deployment time to preserve the intent of the refactoring operations. For example, the refactoring log 110 records a rename operation on a column. At deployment time, the refactoring log 110 prevents the column with the old name from being dropped, along with any data it contains, and an empty column being created with a new name. Hence, certain declarative statements do not need to be appended or prepended to pre-deployment scripts and post-deployment scripts to preserve the data, such as the DROP and ADD statements.

Subsequently, the deployment engine 112 builds the database project by serializing the altered schema definitions, table definitions and/or or column properties into a build output (e.g., a .dbschema file) and creating various other database artifacts, such as settings (e.g., a .sqlsettings file). Then, the deployment engine 112 deploys the database project to the database 102 by generating a script to either create a new instance of the database 102 or update existing schema definitions in the database 102. The deployment engine 112 deserializes the build output and the various database artifacts into an in-computer memory model of the schema definitions, which is represented by the current state model 106. The deployment engine 112 reads the schema definitions of the database 102 and stores these definitions into an in-computer memory model, which is represented by the model 108.

While applying the refactoring log 110 to the model 108 during deployment, the deployment engine 112 stores information regarding these refactoring operations in identity change information 114. In one exemplary implementation, the deployment engine 112 records each model element of the current state model 106 that is affected by the application of the refactoring operations as well as one or more corresponding model elements in the model 108. For example, if a table in the model 108 named “TABLE1” is renamed “TABLE1P”, the identity change information 114 includes both a post-refactored state “TABLE1P” and a pre-refactored state “TABLE1” of the table name.

In one exemplary implementation, in addition to recording a post-refactored and pre-refactored version of a particular model element, the deployment engine 112 also records any composed or hierarchical child model element of the particular model element in the identity change information 114. As an example, if a table is renamed, the deployment engine 112 records each column name. As another example, if a table is moved to another schema, the deployment engine 112 records an index name.

In another exemplary implementation, the deployment engine 112 also records any parent model element with a composed or hierarchical relationship with the particular model element in the identity change information 114. For example, if a column is renamed, the deployment engine 112 records a table name in which the column is composed. In yet another implementation, the deployment engine 112 records one or more peer model elements associated with the particular model element. For instance, the deployment engine 112 records one or more views that reference a table. Furthermore, the deployment engine 112 records any property changes associated with the particular model element.

As a result of the application of the refactoring operations, the model 108 reflects a post-refactored state of the database 102. The deployment engine 112 employs a model comparison module 116 that compares model elements between the model 108 and the current state model 106. Because the model 108 now includes the refactored model elements of the current state model 106, such a model comparison results in an equivalency for these model elements. In order to transform the model 108 back to a pre-factored state, a schema comparison engine 118 undoes or reverts each model element in a post-refactored state back to a pre-refactored state according to one exemplary implementation. For example, the schema comparison engine 118 transforms post-refactored table name “TABLE1P” back to pre-refactored table name “TABLE1”.

In another exemplary implementation, the schema comparison engine 118 modifies a model comparison result produced by the model comparison module 116 to now indicate that the post-refactored model elements in the current state model are updates to corresponding model elements of a pre-refactored state model of the database 102. For example, the schema comparison engine 118 changes a status of the post-refactored model elements from equals to updated.

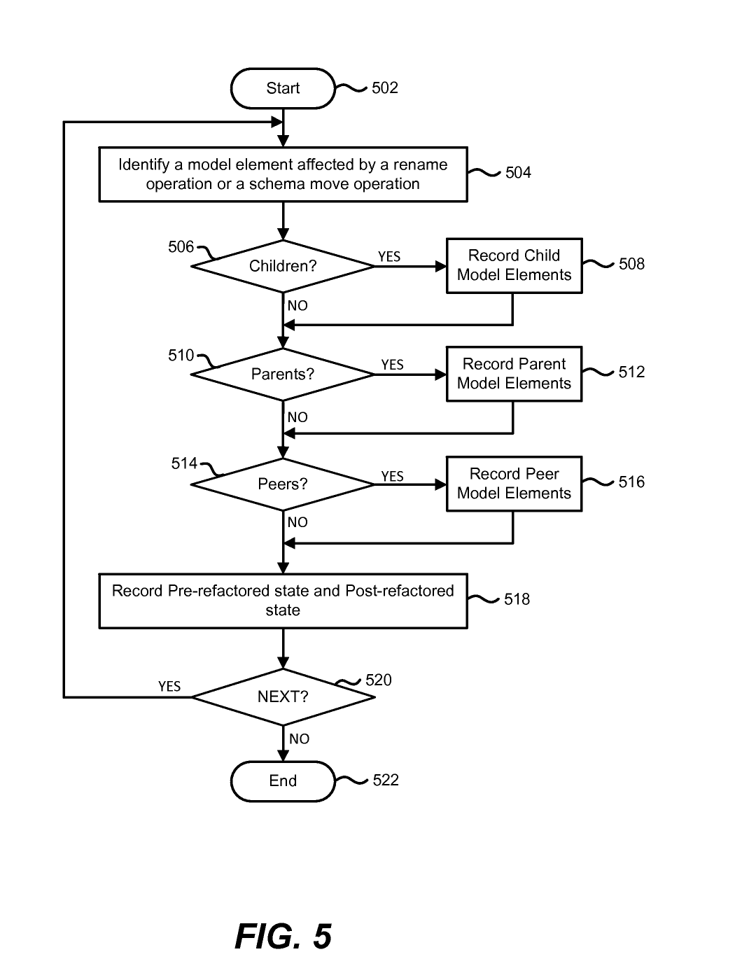

In one exemplary implementation, after modifying the model comparison result, the schema comparison engine creates a script (e.g., SQL script) that alters the model 108 to reflect the pre-refactored state model. A visualization tool 120 uses the model 108 and the modified model comparison result to generate a visual representation 122 of the modified model comparison result. In one exemplary implementation, each model element of the current state model is juxtaposed with a corresponding model element in the pre-refactored state, as illustrated in FIG. 5.

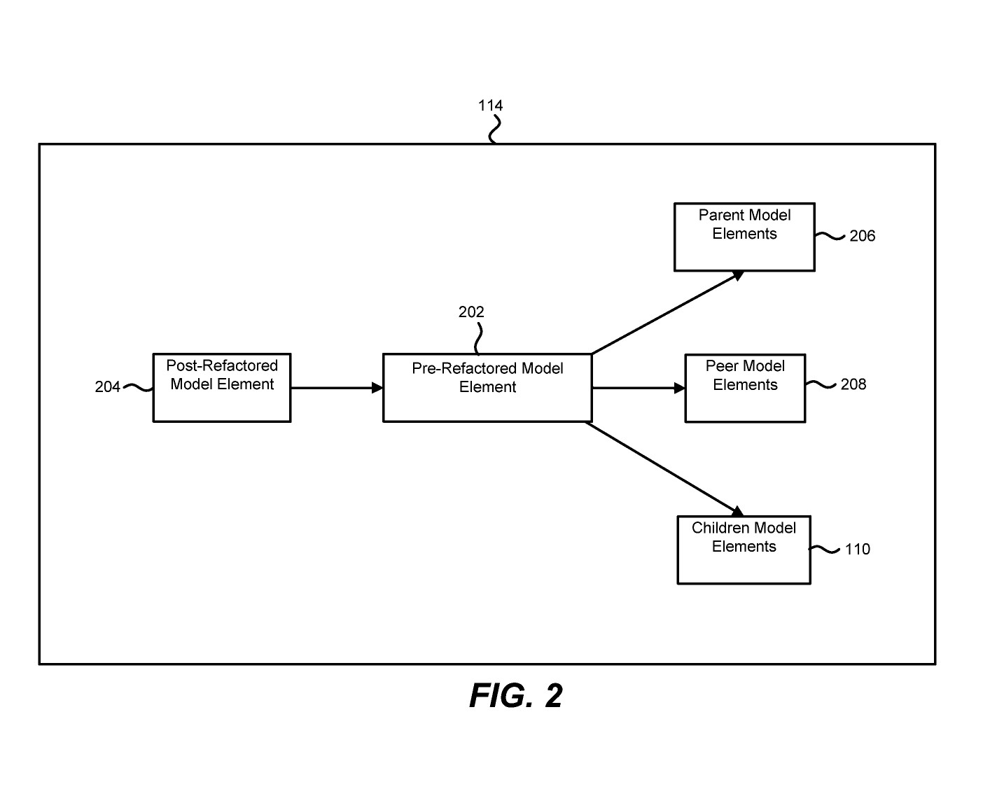

FIG. 2 illustrates exemplary identity change information, such as the identity change information 114 of FIG. 1. While the identity change information 114 includes one example of a pre-refactored model element 202, it is appreciated that the identity change information 114 may include a plurality of model elements affected by execution of refactoring operations. Hence, the identity change information 114 in FIG. 2 illustrates one example embodiment and not a limitation.

In one exemplary implementation, the pre-refactored model element 202 maps to a post-refactored model element 204. As an example, the pre-refactored model element 202 is a table or a column in a database that is renamed. The new table name or column name is stored as the post-refactored model element 204. As another example, the pre-refactored model element 202 is a table that was moved from a schema to another schema. The pre-refactored model element 202 may include “schema1.table_name” and the post-refactored model element 204 may include “schema2.table_name”. Furthermore, the schema comparison engine 118 reverts all references to “schema2.table_name” in a current state model to “schema1.table_name”.

In one exemplary implementation, the deployment engine 112 also records one or more parent model elements 206 that are affected by the refactoring operation being applied to the pre-refactored model element 202. The parent model elements 206 may be related to a composed child or hierarchical child that was renamed or moved to another table or database. As an example, if the post-refactored model element 204 is a renamed table, the parent model elements 206 include a schema or base table name from which the pre-refactored model element 202 is derived. As another example, if the post-refactored model element 204 is a renamed column, the parent model elements 206 include a table name of which the renamed column composes. If, however, a column moved from a table to another table, the parent model elements 206 include a name of the original table.

In one exemplary implementation, the deployment engine 112 also records one or more peer model elements 208 that are affected by the refactoring operation being applied to the pre-refactored model element 202. A peer relationship between two or more model elements represents a dependency by one model element to another model element in an arbitrary manner. The relationship between a view and a table is an example of the peer relationship.

In another exemplary implementation, the deployment engine 112 also records one or more child model elements 206 that are affected by the refactoring operation being applied to the pre-refactored model element 202. A composed parent-child relationship represents one model element that consists of other model elements. The relationship between a table and its columns is an example of the composing relationship. A principle of the composing relationship may be that the two model elements are created at the same time. A hierarchical parent-child relationship differs from the composing relationship because the dependency direction is from child to parent. An example is the relationship between a schema and an owned model element, such as a table or a view, where the table or the view is the child and the schema is the parent.

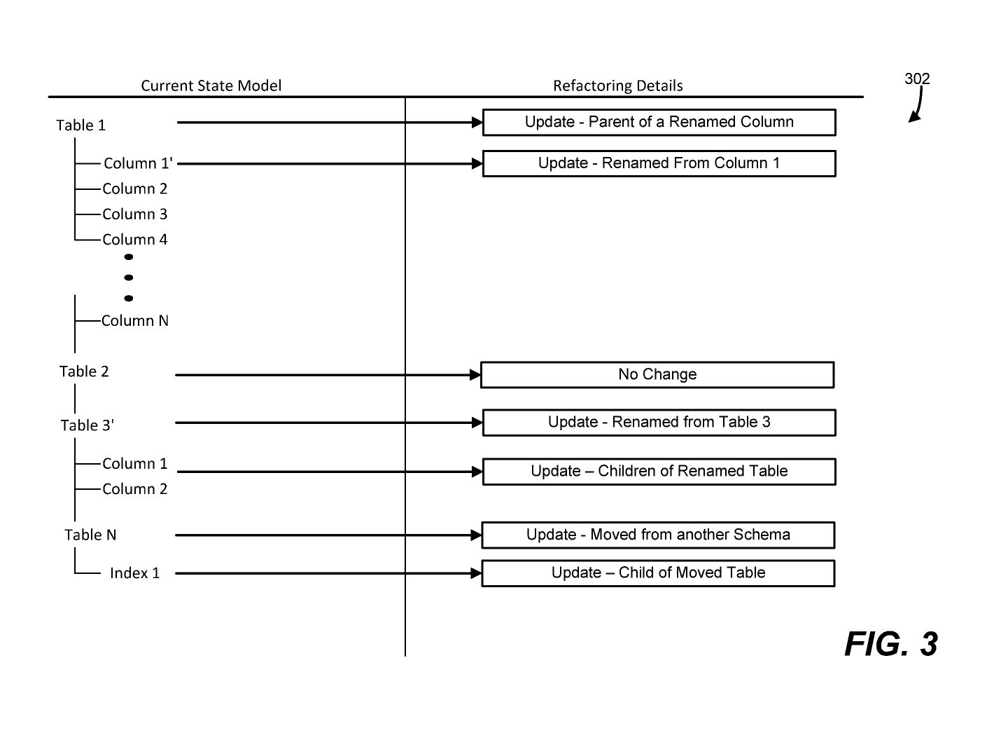

FIG. 3 illustrates an exemplary view of a modified comparison result 302 between a current state model of a database and a pre-refactored state model according to one example implementation. The modified comparison result 302 is depicted in FIG. 3 as a tree-grid view, but it is appreciated that such data is presentable in alternative forms. The modified comparison result 302 includes the current state model in one column and refactoring details in another column.

The refactoring details represent changes made to the pre-refactored state model of the database. For example, the refactoring details indicate that “Table 1” is a parent of a composed child “Column 1′” that was renamed from “Column 1”. Accordingly, both model elements are shown as updated from the pre-refactored state model. While “Table 2” is unchanged, “Table 3′” is updated and renamed from “Table 3”. Furthermore, “Table 3′” includes two columns that are depicted in the refactoring details as children of a renamed table.

In one exemplary implementation, a schema that includes “Table N” was moved to the current state model from another schema in the database or, alternatively, another database. The modified comparison result 302 also indicates that “Index 1” is affected by such a schema move operation because it is a hierarchical child of “Table N”. The schema comparison engine 118 also depicts “Index 1” as renamed whenever a primary key or a unique constraint in “Table N” is renamed (i.e., by a system procedure, such as “sp_rename”). It is appreciated that the modified comparison result 302 may include model elements affected by refactoring operations other than a schema move operation or a rename operation.

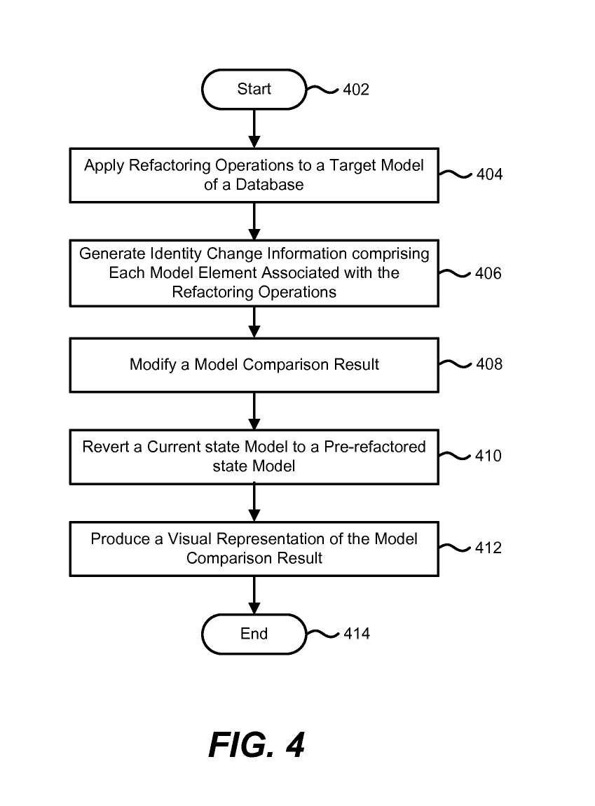

FIG. 4 is a flow diagram illustrating exemplary steps for transforming model elements, associated with a current state model of a database, to a pre-refactored state according to one example implementation. Steps depicted in FIG. 4 commence at step 402 and proceed to step 404 when the deployment engine 112 applies one or more refactoring operations to a target model of a database. Step 406 is directed to generating identity change information comprising each model element associated with the refactoring operations. While applying the refactoring operations, the deployment engine 112 records model elements that are affected by the refactoring operations. In addition to recording each renamed model element or each model element that was moved to another schema, the deployment engine 112 records any parent, child and/or peer model elements according to one exemplary implementation.

Step 408 refers to modifying a model comparison result between the target model and a source model. In one exemplary implementation, the source model refers to a representation of schema definitions and dependencies for an active database project or project file (e.g., .dbschema). The target model may refer to a representation of schema definitions and dependencies that are reverse-engineered from the database and refactored using a refactored log. Because identifiers for model elements in the target model are changed to reflect corresponding model elements in the source model, the deployment engine 112 identifies these refactored model elements as equal. The schema comparison engine 118 modifies the model comparison result by changing a equal status associated with each model element to updated.

Step 410 is directed to a reversion of the current state model to the pre-refactored state. The schema comparison engine 118 modifies schema definitions and dependencies in the current state model. For example, the schema comparison engine 118 changes a renamed model element (e.g., a table or a column) back to a pre-refactored name. In addition to altering a definition of the renamed model element, the schema comparison engine 118 changes a definition for any model element that depends from or references the renamed model element. If a table is renamed, the schema comparison engine 118 modifies a definition for each composed column (i.e., a composed child) as well as a definition for each view that references the table. If a table or column property is changed (e.g., a column with a NOT NULL constraint is changed to NULLABLE), the schema comparison engine 118 alters the table or column definition to revert the changed property back to the pre-refactored state.

As another example, the schema comparison engine 118 modifies a schema definition to include a model element in a pre-refactored state. If a table was moved from a first schema to a second schema, the schema comparison engine 118 alters definitions for both schemas to revert them back to the pre-refactored state. The schema comparison engine 118 removes the table from the second schema and adds the table to the first schema.

Step 412 is directed to producing a visual representation of the model comparison result. As illustrated in FIG. 3, the schema comparison engine 118 produces a tree-grid view of the model comparison result as modified in step 408. The method described in FIG. 4 terminates at step 414.

FIG. 5 is a flow diagram illustrating exemplary steps for creating identity change information comprising each model element that is associated with refactoring operations according to one example implementation. Steps depicted in FIG. 5 commence at step 502 and proceed to step 504 when the deployment engine 112 identifies a model element affected by a rename operation or a schema move operation.

Step 506 refers to a determination as to whether the model element includes any composed or hierarchical children. If the model element corresponds with one or more child model elements, the method described in FIG. 5 proceeds to step 508 where post-refactored and pre-refactored states of the one or more child model elements are recorded in the identity change information. If, however, the model element does not correspond with any composed or hierarchical child model elements, the method described in FIG. 5 proceeds to step 510.

Step 510 refers to a determination as to whether the model element depends on a parent model element. If the model element is a composed or hierarchical child of the parent model element, the method described in FIG. 5 proceeds to step 512 where post-refactored and pre-refactored states of the parent model element is recorded in the identity change information. If, however, the model element does not correspond with any parent model element, the method described in FIG. 5 proceeds to step 514.

Step 514 refers to a determination as to whether the model element is associated with any peer model element. If the model element has a relationship with one or more peer model elements, the method described in FIG. 5 proceeds to step 508 where post-refactored and pre-refactored states of the one or more peer model elements are recorded in the identity change information. If, however, the model element does not have a relationship with any peer model elements, the method described in FIG. 5 proceeds to step 518.

Step 518 is directed to recording a pre-refactored and a post-refactored state of the model element that is affected by the rename operation and/or the schema move operation. Step 520 is directed to a determination as to whether there is another refactoring operation to apply to a model (i.e., a target model). If there is a next refactoring operation, the method described in FIG. 5 returns to step 504. If, on the other hand, there are no more refactoring operations, the method described in FIG. 5 proceeds to step 522. Step 522 refers to a termination of the method described in FIG. 5.

### Exemplary Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

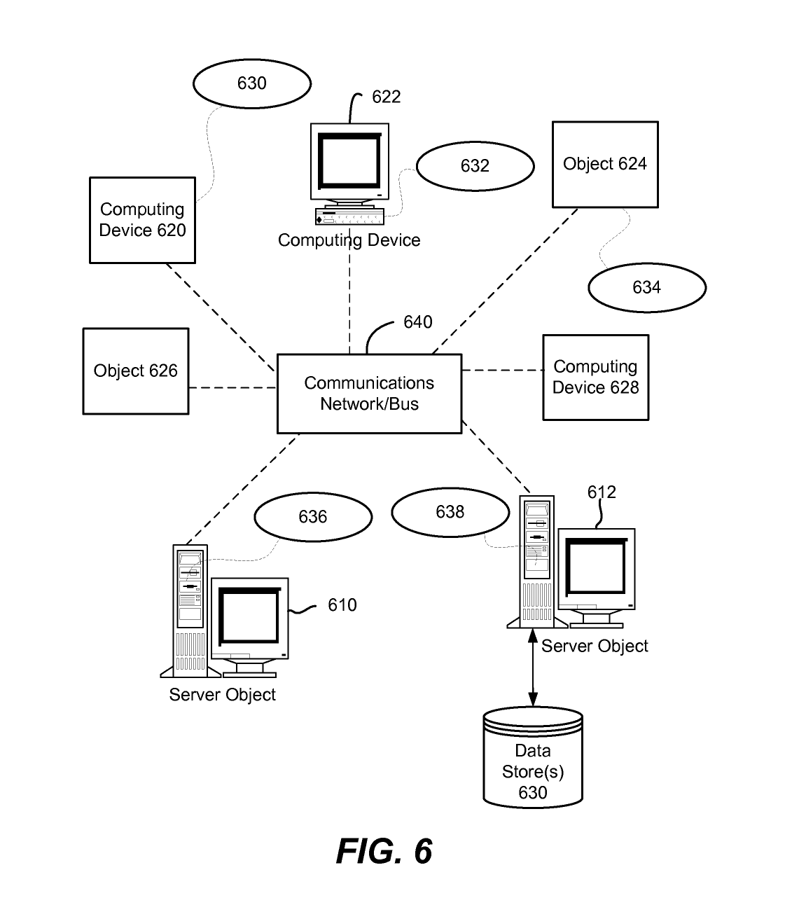

FIG. 6 provides a schematic diagram of an exemplary networked or distributed computing environment. The distributed computing environment comprises computing objects 610, 612, etc., and computing objects or devices 620, 622, 624, 626, 628, etc., which may include programs, methods, data stores, programmable logic, etc. as represented by example applications 630, 632, 634, 636, 638. It can be appreciated that computing objects 610, 612, etc. and computing objects or devices 620, 622, 624, 626, 628, etc. may comprise different devices, such as personal digital assistants (PDAs), audio/video devices, mobile phones, MP3 players, personal computers, laptops, etc.

Each computing object 610, 612, etc. and computing objects or devices 620, 622, 624, 626, 628, etc. can communicate with one or more other computing objects 610, 612, etc. and computing objects or devices 620, 622, 624, 626, 628, etc. by way of the communications network 640, either directly or indirectly. Even though illustrated as a single element in FIG. 6, communications network 640 may comprise other computing objects and computing devices that provide services to the system of FIG. 6, and/or may represent multiple interconnected networks, which are not shown. Each computing object 610, 612, etc. or computing object or device 620, 622, 624, 626, 628, etc. can also contain an application, such as applications 630, 632, 634, 636, 638, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 6, as a non-limiting example, computing objects or devices 620, 622, 624, 626, 628, etc. can be thought of as clients and computing objects 610, 612, etc. can be thought of as servers where computing objects 610, 612, etc., acting as servers provide data services, such as receiving data from client computing objects or devices 620, 622, 624, 626, 628, etc., storing of data, processing of data, transmitting data to client computing objects or devices 620, 622, 624, 626, 628, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 640 or bus is the Internet, for example, the computing objects 610, 612, etc. can be Web servers with which other computing objects or devices 620, 622, 624, 626, 628, etc. communicate via any of a number of known protocols, such as the hypertext transfer protocol (HTTP). Computing objects 610, 612, etc. acting as servers may also serve as clients, e.g., computing objects or devices 620, 622, 624, 626, 628, etc., as may be characteristic of a distributed computing environment.

### Exemplary Computing Device

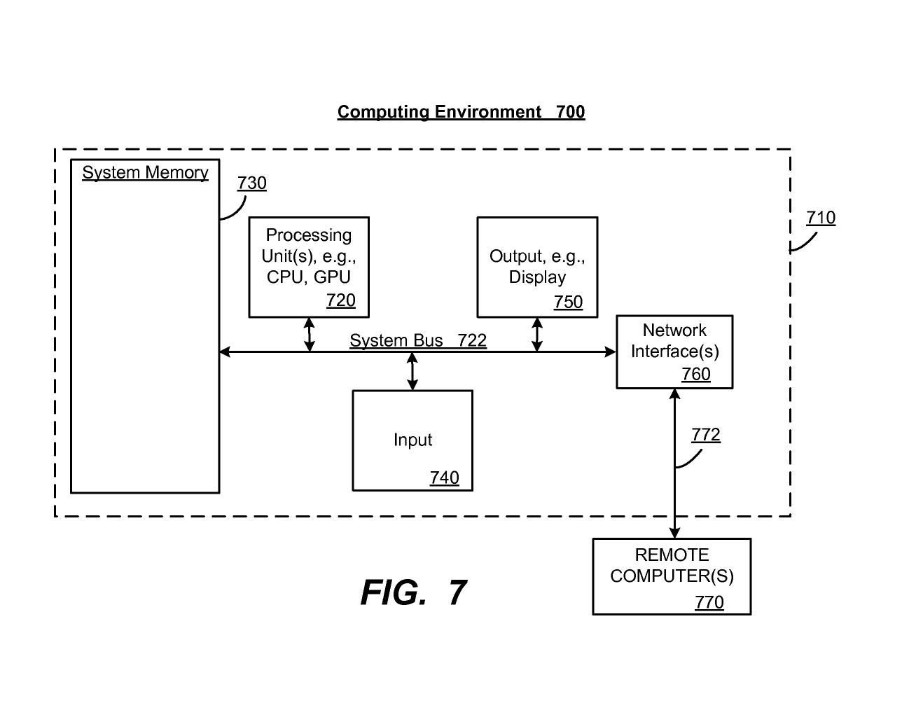

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 7 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 7 thus illustrates an example of a suitable computing system environment 700 in which one or aspects of the embodiments described herein can be implemented, although as made clear above, the computing system environment 700 is only one example of a suitable computing environment and is not intended to suggest any limitation as to scope of use or functionality. In addition, the computing system environment 700 is not intended to be interpreted as having any dependency relating to any one or combination of components illustrated in the exemplary computing system environment 700.

With reference to FIG. 7, an exemplary remote device for implementing one or more embodiments includes a general purpose computing device in the form of a computer 710. Components of computer 710 may include, but are not limited to, a processing unit 720, a system memory 730, and a system bus 722 that couples various system components including the system memory to the processing unit 720.

Computer 710 typically includes a variety of computer readable media and can be any available media that can be accessed by computer 710. The system memory 730 may include computer storage media in the form of volatile and/or nonvolatile memory such as read only memory (ROM) and/or random access memory (RAM). By way of example, and not limitation, system memory 730 may also include an operating system, application programs, other program modules, and program data.

A user can enter commands and information into the computer 710 through input devices 740. A monitor or other type of display device is also connected to the system bus 722 via an interface, such as output interface 750. In addition to a monitor, computers can also include other peripheral output devices such as speakers and a printer, which may be connected through output interface 750.

The computer 710 may operate in a networked or distributed environment using logical connections to one or more other remote computers, such as remote computer 770. The remote computer 770 may be a personal computer, a server, a router, a network PC, a peer device or other common network node, or any other remote media consumption or transmission device, and may include any or all of the elements described above relative to the computer 710. The logical connections depicted in FIG. 7 include a network 772, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising, transforming model elements associated with a current state model of a database to a pre-refactored state, including creating identity change information comprising each model element that is associated with an application of refactoring operations on the database, creating a pre-refactored state model of the database using the identity change information and producing a visual representation of a comparison between the pre-refactored state model and the current state model.

2. The method of claim 1, wherein creating the identify change information further comprises when applying the refactoring operations on the database, recording the pre-refactored state and the post-refactored state of the each model element in the identity change information.

3. The method of claim 1, wherein creating a pre-refactored state model of the database further comprises modifying a model comparison result between the current state model and a pre-refactored state model of the database using the identity change information.

4. The method of claim 1, wherein creating the identify change information further comprises identifying a model element that is a composed child or a hierarchical child of a parent model element in a post-refactored state.

5. The method of claim 3, wherein modifying the model comparison result further comprises changing a status associated with the each model element to updated status.

6. The method of claim 1, wherein creating the identify change information further comprises identifying a model element that is a parent of a composed child or hierarchical child in a post-refactored state.

7. The method of claim 1, wherein creating the identify change information further comprises identifying a model element that is a peer of another model element affected by the refactoring operations.

8. The method of claim 1, wherein creating the identify change information further comprises identifying a rename of a model element.

9. The method of claim 1, wherein creating the identify change information further comprises identifying a model element that is affected by a schema move operation.

10. The method of claim 1, wherein creating the identify change information further comprises identifying a model element that is affected by a property change.

11. In a computing environment, a system that is configured to revert a post-refactored state model of a database to a pre-refactored state model, comprising, a deployment engine configured to record, in identity change information, a pre-refactored state and a post-refactored state of each model element that is affected by execution of refactoring operations, and a schema comparison engine configured to create the pre-refactored state model of the database using the identity change information.

12. The system of claim 11, wherein the schema comparison engine modifies a comparison result between a current state model and the pre-refactored state model

13. The system of claim 11 further comprising a visualization tool that generates a visual representation of the comparison result.

14. The system of claim 11, wherein the schema comparison engine identifies a model element that is a composed child or a hierarchical child of a refactored parent model element.

15. The system of claim 11, wherein the schema comparison engine identifies a model element that is a peer of a refactored model element.

16. The system of claim 11, wherein the schema comparison engine identifies a model element that is a parent of a refactored composed child or refactored hierarchical child.

17. The system of claim 11, wherein the schema comparison engine identifies a model element that is affected by a schema move operation or a rename operation.

18. One or more computer-readable media having computer-executable instructions, which when executed perform steps, comprising:
creating identity change information comprising each model element that is associated with an application of refactoring operations on a database, wherein the each model element is in a post-refractored state; and
reverting a current state model of the database into a pre-refactored state model using the identity change information.

19. The one or more computer-readable media of claim 18 having further computer-executable instructions comprising:
modifying a model comparison result between the current state model and the pre-refactored model of the database, wherein a status associated with the each model element is changed to an updated status.

20. The one or more computer-readable media of claim 18 having further computer-executable instructions comprising:
producing a visual representation of the model comparison result.
